(19) United States
(12) Patent Application Publication
(10) Pub. No.: US 2023/0380381 A1
(43) Pub. Date: Nov. 30, 2023

(54) Comprehensive Wireless Verbal Cue Training System for Domesticated Animals

(71) Applicant: Rebecca Ann Metcalfe, Port Angeles, WA (US)

(72) Inventor: Rebecca Ann Metcalfe, Port Angeles, WA (US)

(21) Appl. No.: 17/752,143

(22) Filed: May 24, 2022

(51) Int. Cl. A01K 15/02; A01K 27/00

(52) U.S. Cl. CPC A01K 15/021; A01K 27/009

(57) ABSTRACT

Inventor observed a universal pattern within mammal groups regarding acceptable/unacceptable behavioral learning systems used to set the rules for correct coexistence within respective species. Using this same pattern, the inventor developed a very specific communication system based on the human language using verbal cues and tone variations that the domesticated animal can easily understand. This invention is the electronic conversion of the inventors training methods using this stepped process for self-teaching domesticated animals our human verbal cues for various activities using wireless technology to accomplish said tasks.

### FIELD OF INVENTION

Inventor observed a universal pattern within mammal groups regarding acceptable/unacceptable behavioral learning systems used to set the rules for correct coexistence within respective species. This invention is the wireless based electronic conversion of the inventors training methods using these universal patterns and designed to teach collared, harnessed or haltered domesticated animal(s) (“CHHDA's”) how to successfully and understandingly co-exist within a human environment. This system automatically enforces the rules associated with human co-existence, allows the CHHDA to quickly learn human verbal cues, self teaches the CHHDA to understand the difference between acceptable and unacceptable behavior verbiage, right/wrong decisions, allows a stepped warning process to encourage thoughtful choices, can be used to assist in building a solid routine, and quickly associate human verbal cue relationship with each presented activity and/or requested task even if the owner isn't present. This invention and its training method is progressive in features to build a solid verbal communication system from start to finish to accommodate most all advanced CHHDA disciplines. Where most CHHDA's electronic devices currently on the market are targeted towards a human operated device such as a buzz/bell/electric shock system, this invention focuses solely on humanely and safely assigning indisputable power to human verbal cues using wireless components with a progressive or regressive ultrasonic sound triggered when the verbal cue warnings are ignored. Since owners/handlers may not have a corrective device remote on their person, this invention is designed to humanely and safely place unquestionable power into the humans verbal cues through consistent and precise communication methods.

### BACKGROUND

Mammals understand how to be mammals within their respective species. They know their species language and group rules. But domesticated animals don't live within their respective species with the language and rules they understand. They live in a human environment where all avenues of their new life are foreign to them. When humans add a domesticated animal into their human environment, some humans take this responsibility and training seriously, molding their domesticated animal into its best self in order to create a valued partnership within various jobs/disciplines. But the majority of owners of domesticated animals, especially first time owners, fail to understand how to teach their new household member the correct rules of human co-existence. These humans are reactive instead of being proactive in their training methods. Because of this the domesticated animal may become an unruly, undisciplined and an uncontrollable nuisance falling short of the owners expectations. Humans refer to these failed domesticated animals as problem animals and are frequently re-homed, surrendered to already heavily burdened shelters, abandoned and/or euthanized. Not only have these type of owners failed their non-human member(s), they have also cheated themselves out of an immense opportunity to mold their domesticated animal into a valued and productive family member.

Since domesticated animals are what they are, they associate human rules with the presence of the owner since, if the owner isn't around, there are no corrective measures to enforce the rules. In the wild, the subordinate group members will wait until group dominates eat their fill and then the subordinates will scavenge up the remaining scraps. In a human environment, the human is the dominate and the non-humans are subordinate. Because of this natural system, animals will wait to counter surf or garbage dive when humans abandon the meals which means if a human isn't present, left over food is available for the subordinates. Being scavengers in a respective species group is instinctual for survival, being a scavenger within a human group is considered being a “problem animal”. Human rules are much different than what would be a natural and instinctual activity in the wild.

Separation anxiety in canines can be a huge problem. They are pack animals and in nature as they mature, they are invited to join the pack in the hunt. When left behind, they don't understand why they are left behind. They are ready for a job, ready to join “the pack” . . . . they are ready! Secondly, canines get bored and the only excitement and positive stimulation they experience is when the human is present. This situation causes them to be apprehensive on whether or not their human will return since this is heavy on their bored to death minds. With being able to electronically set a routine to include brain game activities this system helps to eliminate this unacceptable and most times, destructive behavior.

Many canine owners, especially in the hunting breeds, use electronic shock collars in order to obtain human rule compliance. Many users of this device abuse the system and cause great harm to the canine. This type of device is triggered, many times without warning, and many times with the recipient not really aware of the infraction it has created and usually always without any warning to associate the infraction with. But the problem with this is, the human isn't always present when an infraction has been conducted so it isn't very consistent communication. This type of system requires a human to be present to push the buttons at the correct time and requires the human to be “watching” at all times.

Many owners will continuously keep the tightly fitted shock collar on a canine thereby creating puncture wounds from long term constant and abusive use. There are those that use the collars correctly and the shock collars can be a very effective tool in experienced hands however in the hands of an unskilled handler the results can be devastating. For this reason shock collars have been banned/outlawed in many countries leaving gun dog handlers little or no control of a hunting dog that has escalated into an out of control bird chasing frenzy. Other electronic devices do not teach the domesticated animal human rules, but instead redirect to another activity which in all reality encourages unacceptable behavior with a re-direct reward such as a treat or a favorite toy. Humans are basically stating that if you do this bad thing, I will reward you with something good. Other electronic devices currently on the market may use a noise dissuasion system using sounds the CHHDC is already fearful of such as thunder, shaking a can of rocks or the sound of a vacuum cleaner. Although that system may be effective, all it does is increase a fear or associated anxiety every time that noise is sounded whether used within a disciplinary method or not. Those systems require a human operator in order to administer the associated discipline. Some GPS based inventions used for wireless fencing do not give a verbal warning of boundary encroachment but only give a beep and then an electric shock when the boundary has been approached or breached. Many high strung dogs will take the shock in order to get to whatever is on the other side of the invisible fence. Once the canine has cleared the wireless fence boundary they are free to roam without fear but since the reward on their allocated property isn't enough to convince them to take the shock to come back home, they continue to enjoy their freedom. Some anti-bark collars are effective with use of ultrasonic sounds played to discourage multiple barking episodes, but do not give a warning or reward for compliance only an immediate disciplinary action. The use of a water spray bottle to discipline a domesticated animal may be effective, but it teaches the animal to fear or dislike water/swimming and for hunting dogs, this isn't acceptable. Non electronic devices such as prong or choke collars are capable of achieving results, but when used by inexperienced handlers can cause significant physical damage to the canine. Harnesses with front pull devices geared towards managing the tug and drag dog do nothing to train the animal, only affording a consistent corrective tug a war between the canine and owner. Inexperienced owners that only use a standard canine collar and leash without obedience training will never win a battle in a canine/human tug a war. The canine will always win by either over powering the handler or pulling out of the collar thereby teaching the domesticated animal how to get away from human constraints.

Through decades of observance, the inventor recognized within all mammal communities each respective species have very distinct behavior molding communication steps. Even though the communication styles vary, the stepped process remains the same. For positive reinforcement grooming, playful interaction, and just chilling alongside the elder is the greatest reward. But there are rules of interacting with a group elder. These rules are taught to the juveniles by the group elders using a very specific 3 stepped process. In humans, or at least in the inventors family, if we were being disobedient, a single finger was raised by an elder and relayed as “That's 1”, if we continued, the 2nd finger was presented “That's 2”, we never dared to push it to “That's 3”. We were given warnings and very aware of the consequences if we pushed it further. We were taught to choose wisely or suffer those consequences. In the canine pack juveniles are also taught this system and given the opportunity to choose wisely. The juvenile pup harassing an elder by biting or jumping on them will receive a warning consisting of a growl and sometimes barring teeth “That's 1”, if ignored, communication escalates with the elder standing over juvenile with barred teeth with an unmistakably communicated “That's 2” with a progressive “I dare you to push it further” stance and if ignored, a physical punishment is rendered. These steps can be observed in almost every mammal. This stepped warning system is universal and unmistakably understood. Inventor converted these steps into a simplistic human verbal warning system designed to use these same basic steps to teach domesticated animals our human coexistence rules using consistent human owner's verbiage for various programmable activities whether the owner is within sight or not. Since domesticated animals do not instinctually understand human language, each step of this electronic system builds on teaching simple human verbal commands for various activities and rule enforcement using a method they instinctively understand. By teaching verbal cue/activity association consistently, the domesticated animal can quickly understand our intentions, the rules of the game as well as the stepped process for unacceptable behavior with an opportunity to choose wisely.

In order to achieve the level of this type of communication much time and energy must be spent. Not all humans are afforded this type of time commitment even though they have very good intentions. This invention is the electronic version of the inventors training methods that takes into consideration all of the above subject matter by allowing the domesticated animal to self-learn our human system while also teaching the owner the incredible journey of being able to accurately and efficiently communicate with their domesticated animal(s). Since an owner/handler may not always have a remote control handy, they will always have their voice/verbal cues. This invention was created to instill power into those verbal cues without harming the domesticated animal. This system was also created to take the guess work out of training a domesticated animal, thereby creating a valued partnership capable of consistent response.

### DESCRIPTION OF PRIOR ART

There are several computer aided systems found most notable Kates (U.S. Pat. No. 7,861,676 B2) focusing on pet management. The only system found with combined features of wireless technology using owners own voice recordings is Torres (U.S. Pat. No. 10,575,497 B2). Torres describes “audio messages in a memory of a collar module to be worn by the animal, audibly broadcasting a user-selected audio message simultaneously with the user physically controlling the animal . . . .” Further stating “For example, in the invention's first mode of operation, if the pet is not allowed on the couch, the user would record a message admonishing the pet for this behavior. The user would then use the Command Module to trigger the playback of the admonishing message while physically removing the pet from the couch. The user would repeat this playback and removal process as many times as required. Eventually the pet will learn to associate the audible message with the desired behavior of getting off the couch without the owner needing to physically remove the pet.” . . . “At this time the user will activate the invention's second mode of operation by activating a Proximity Signaling Module and placing it under the cushion of the couch. Now, when and only when the pet jumps on the couch, the Collar Module detects its proximity to the Proximity Signaling Module and automatically triggers the playback of the appropriate admonishing message. The pet hears the message and jumps off the couch.”

### SUMMARY

This invention is the electronic conversion of the inventors training methods for teaching the domesticated animals our human verbal cues for various activities. This system was developed to help the domesticated animal understand the difference between acceptable and unacceptable behavior verbiage, understand the rules of co-existing within a human environment regardless if the human is present or not, associate owners verbal cues with specific activities/tasks, and to supply the owners of domesticated animals with an effective communication system that produces a solid understanding of expectations. Using a universal mammal communication pattern for acceptable/unacceptable behavior, the inventor developed a very specific communication system based on the human language using verbal cues and tone variations that the domesticated animal can easily understand using a stepped process universal to all mammals. This invention is comprised of wireless components to relay digital information between two units; the receiving unit hereinafter known as the “Slave” device, and the transmitting unit(s) hereinafter known as “Master” devices. Owners audio verbal cues are recorded and configured for correct length and format via an online instructional software platform for up to 200 different verbal cues which allows multiple humans to record their specific commands in their specific voice. Once recorded, the audio files are downloaded to a SD card or directly onto the “Slave” devices audio chip via a USB connection. Because audio files can easily become distorted, corrupted and unrecognizable during transmission, audio files reside within the receiving or “Slave” device such as a collar, harness, or halter for timely transmission, crisp sounds and without interference or static. The transmitting device “Masters” are either standalone or handheld units, which when activated, transmit the assigned digital code to the receiving “Slave” device instructing the correct audio file to be played. Whether acknowledging a correct choice has been made, infraction of rules, an activity needs to be performed or a routine met, this concise system consistently teaches the collared, harnessed or haltered domesticated animal our human language and puts indisputable power into the human voice.

### BRIEF DESCRIPTION OF DRAWINGS

FIG. 1 The “Slave” unit with a possible layout for the component housing

FIG. 2 The Masters, includes 5 variations of the Master remote controls

FIG. 3 The Guardian, standalone master proximity communication

FIG. 4 Joystick remote possible communication configuration

FIG. 5 Handheld possible configurations for auto distance communication

FIG. 6 Potential configuration for video cam on goggles and “slave” placement on harness

### DETAILED DESCRIPTION OF DRAWING

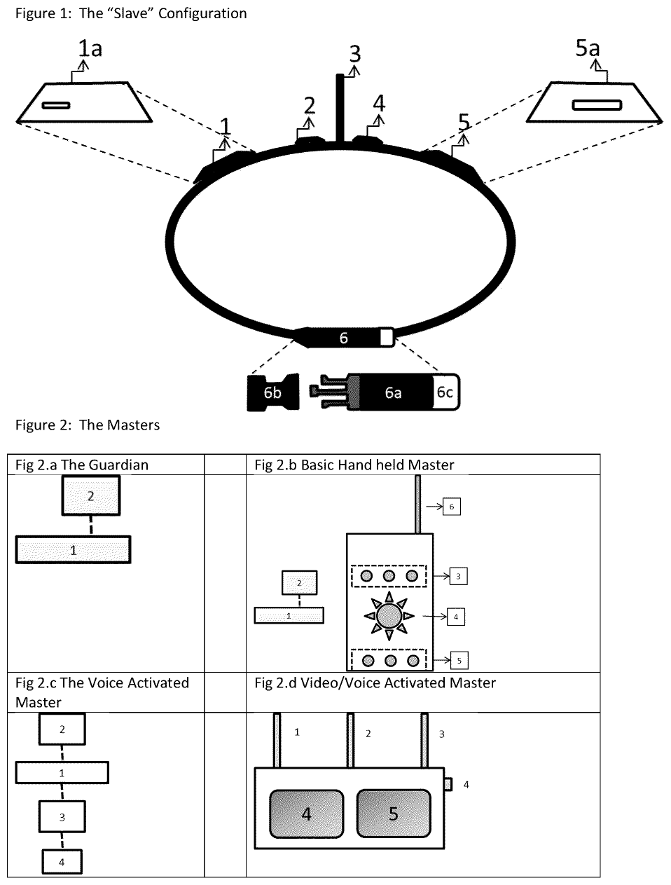

FIG. 1 The “Slave” device reside within the collar, harness or halter itself and constructed within a miniaturized linear circuit configuration of electronic components in order to reduce bulk, unwanted rotation and aesthetics. There are several configurations available for progressive accommodations from basic to advanced units. The “Slave” circuitry is housed in individual waterproof enclosure which can be easily removed in order to replace a damaged unit or upgrade the unit without having to replace the entire housing. The “Slave” device is comprised of a microprocessor, a wireless receiver, a sound board with an audio storage card such as an SD card/reader or an audio data chip, a slot for the wireless communication of choice compromising of WiFi, Bluetooth or LoRa specially designed chips, with an interfaced audio playback system to accommodate each components individual requirements for MOSI and MISO ports, a replaceable rechargeable battery system and an on/off switch.

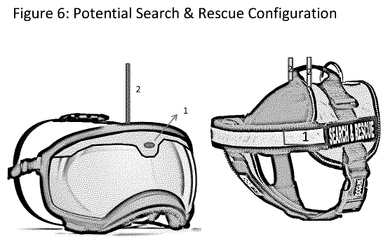

The “Slave” unit configured in this drawing represents a potential canine collar. In order to distribute the weight of the collar, each component is fitted within its own waterproof containment compartment connected with flex circuitry to accommodate the contours around the neck. FIG. 1a houses the microprocessor, power management system and the wireless communication chip either hard wired within the unit or configured for a port to interchange the various available forms of wireless components. FIG. 1 also contains the USB port for charging the rechargeable lithium replaceable battery and/or to update the software as needed. FIG. 1.2 represents the buzzer for sounding the ultrasonic frequencies as dictated by activity non-response. FIG. 1.3 represents the wireless respective antennae. FIG. 1.4 represents the placement of the speaker that sounds the audio file as triggered by the Master. FIG. 1.5 represents the sound card and amplification units with FIG. 1.5a being a port for inserting the SD audio card. FIG. 6 is the rechargeable battery housing with the power/ground wires running through the center area of 1.6b and when connected to1.6a, turns on the unit or when detached turns off the unit in order to save battery. FIG. 1.6c is used to connect to and adjust the collar for fitting to the canine.

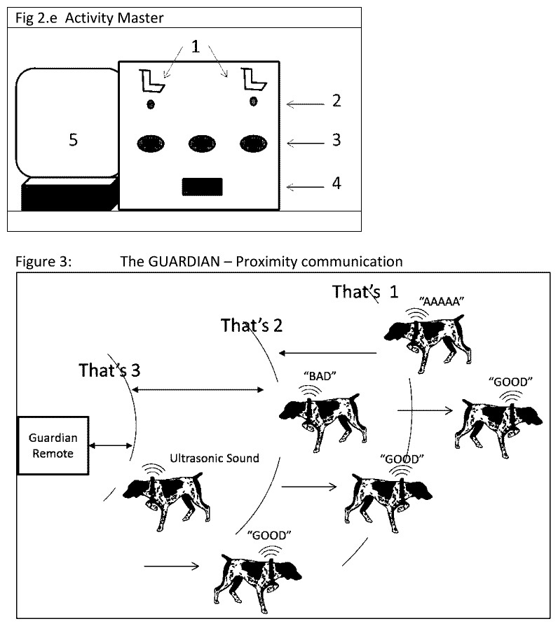

FIG. 2 The “Masters”

There are basically five types of “Master” devices, all configured with components for wireless communication and also contain an SD type wireless card slot to accommodate the desired wireless method of the user. The sole purpose of the “Master” is to transmit a digital code to the “Slave” device triggering which audio file is to be sounded on the “Slave” device. Each “Master” is configured with a primary microprocessor specifically programmed to transmit a digital code to the “Slave” device. The Masters are in constant communication with the Slave in order to calculate when to trigger the various codes relating to proximity between the Slave and the Master. Each of the “Masters”, from basic to advanced, are all based on this foundational configuration.

FIG. 2.1 The Guardian “Master” is designed specifically to protect restricted areas and unauthorized activities, are responsible to calculate the infraction and to automatically transmit the related digital codes to the “Slave” unit(s) indicating which audio file the “Slave” unit is to sound. These are “Master” standalone units and do not require human interaction in order to operate. Each Guardian is programmed with its own specific assignment(s) and configured with specific proximity code. The Guardian system is only capable of instructing the “Slave” for correct/infraction activities, reward/warning verbal cues and ultrasonic disciplinary audio trigger codes with the sole purpose to self-teach the domesticated animals the foundational human language that distinguishes the difference between acceptable and unacceptable behavior. Using the mammal universal stepped system, these human verbal cues establish/enforce household rules and the consequences of ignoring the verbal warnings. This teaches the domesticated animal that rules are rules whether a human is present or not.

FIG. 2.2 This “Master” is a handheld, owner/handler operated remote with limited features to include the behavioral “Guardian” language and obedience type verbal cues. The verbal cues available are limited due to the remotes size and functionality. This “Master” can be configured in a standard style hand held device with selection buttons or a joystick option. For the button option, each push button is individually connected to a dedicated microprocessor pin, thereby limiting the number of available verbal cues based on the microprocessor pin availability. For the joystick type option, this increases the available verbal cues as the joystick requires less dedicated microprocessor pins and verbal cues can be configured for multiple Horizontal/Vertical position (x/y) combinations. In the joystick configuration, (1) represents the microprocessor, (2) represents the transmitter or transceiver, (3) represents a row of buttons for the ability to select 1, 2 or both collared, harnessed or haltered animal, (4) represents the joystick controller, (5) represents the stepped levels of the warning/discipline buttons. Each vertical and horizontal position produces a specific X/Y axis digital number. The combination of this X/Y axis can be used to individually program specific verbal cue activation. This joystick “Master” was configured with the mobility challenged individual in mind in order to compete remotely in agility type events where voice activated devices would not be very effective due to background “crowd” and loud speaker type noise interference. This “Master” can also be configured in a touch screen OLED type remote to scroll through the desired commands as needed.

FIG. 2.3 This “Master” was designed for advanced wireless communication for off leash liberty work, hunting dogs and/or search and rescue dogs. This device is hands free voice activated allowing up to 200 different voice activated verbal cues. This “Master” is configured with (1) a primary microprocessor connected to (2) a long range transmitter or transceiver, (3) the voice activation module, with connection to (4) a microphone headset. This “Master” unit is powered with a removable rechargeable battery system. The owners verbal cues are recorded onto the voice activation module device via a USB port and accessed through an online instructional software platform. Each voice activation cue is assigned a unique line item digital file code. When the voice activated verbal cue is spoken into the headset microphone, the microprocessor then transmits the correct digital line item code which is received by the “Slave” device to play the corresponding digital numbered audio file. This configuration was conceived and designed for hands free verbal guidance of the working dog.

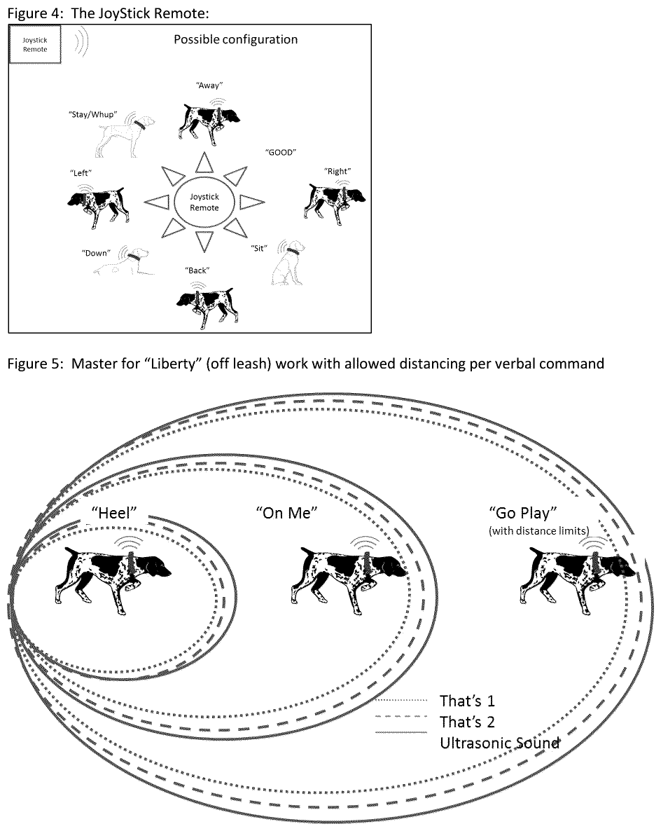

FIG. 2.4 This “Master” is configured the same as FIG. 4.3 for voice activated hands free verbal instruction and designed specifically for the hunting and/or Search and Rescue dog. This “Master” includes a toggled viewing screen for the digital map/location stream of the GPS (optional) location of the “Slave” device and a video streaming screen received from the specialty “Slave” video camera goggles. This “Master” is configured in three separate functionalities, each with their own microprocessor, various types of uniquely channeled transmitters or transceivers to accommodate each task, power supply systems required for each unit and each with their own antennae.

For the Search and Rescue dog, this Master allows the handler the ability to remain in the staging area and verbally instruct the canine through difficult terrain, debris of collapsed buildings, etc. Using both the video stream and the GPS location/altitude the handler can communicate with the canine through various verbal cues to include activities such as simple instructions to assist a victim. This system, given the number of excess verbal cue space available, can be used to communicate with the conscious victim using simple yes/no questions while having the canine direct the camera towards the victim. With the camera located on the S&R canines goggles, the handler can instruct the canine to look left, look right, look up, look down, etc in order to give a better visual of the overall situation. Once the victims situation has been analyzed, the handler can then evaluate the necessary resources required for extraction or if the victim can walk out, the canine can be instructed to “Take me home” and the victim can follow the dog out.

For the S&R canine at a collapsed building site, especially in a situation where human entry is unsafe, too small or difficult, the canine can be sent in and instructed to “dig”, “go through”, “back up”, “go under”, etc . . . . in order to transport life-saving supplies to a trapped victim.

For the hunting dog, this system allows the ability to constantly communicate with the canine in order to direct the canine to the appropriate location of a downed bird. With the video goggles this system allows the handler to see exactly what is happening with the long range work for safety measure, i.e. “Leave it” if confronted with a poison snake, a skunk, or another wild animal.

FIG. 2.5 Activity Unit Master. The “Activity” units are standalone “Master” devices and are used to self-teach the association between specific verbal cues and the programmed activity and/or task. Each unit is configured with a transceiver, Wi-Fi or Bluetooth (options), proximity controllers, touch sensor screens, activity hooks, tag sensors, a port for add on activities, a treat dispenser, a power port, and a battery power system option. These are designed with sensors to discourage mauling such as excessive vibration or tilt sensors which if activated will relay the appropriate digital codes using the Guardian system language.

These units require specific named tasks to be performed in order to activate the treat dispenser unit. The Activity units were designed to start with simple tasks such as “touch it” using the touch sensors and progress through various advanced requests whether associating the name with an item or learning verbal cues for activities such as turning on/off a light switch to finding named toys and putting them in the bucket. At first the verbal code sent from the Activity unit to the “Slave” is triggered as the task is performed and after a preprogrammed number of instances have been met will begin to trigger the associated verbal cue as the close proximity detectors are activated by the “Slave” and “Master” communication thereby becoming “instructions” and connecting the specific activity to the specific verbal cue. The Activity Master can be programmed for setting a training routine via a Wi-Fi computer interface. When activated, a “Here/Come/Dogs name” etc digital code/signal will be sent to the Slave to activate the correct audio file to be played. As the Slave approaches the unit, as determined by the proximity detection, a “good” is sounded and a treat dispensed. This activity teaches a “recall” based on owners verbal cues. Smaller Activity units can be placed around the house or yard for brain game activities to reduce home destruction boredom, separation anxiety and/or setting a daily routine such as placing a condensed unit outside a doggie door that sends the “Slave” unit the code for “Outside” in order to assist in toilet training. Units can also be placed within the crate for “Go to bed” verbal cues and when complied with, a long lasting chew can be dispensed to encourage a “settle” in preparation for sleep.

The Treat Dispenser (5) is electronically controlled through the Activity units. The treat dispenser is configured with a microprocessor connected to an Activity unit via an interface for individual units and Wi-Fi connectivity or a USB connection for multiple units, a Servo type motor with its own power supply, anti-mauling tilt/vibration sensors that will activate the Guardian language, a dispensing tray and a treat/dry food storage container. The treat/dry food storage container can afford the animal's full daily allotment of dry food or special treats. For the canine that gulps down their food, this system becomes a work/learn for your dinner game which encourages interaction with the units.

The “Activity” units were designed to accommodate multiple task interaction. The “Touch It” Activity unit is configured with multiple touch (3) screen sensors and when in contact with a nose, will send a “good/yes” digital code to the “Slave” device and trigger a treat to be dispensed. These sensors can also be used for teaching left, right, or away in preparation for outside directional cues. At first whenever the screen is touched whether intentional or out of curiosity the unit will trigger a digital code to be sent to the “Slave” device and a “good/yes” cue is played on the “Slave” and the Activity unit will dispense a treat in order to teach the performance required to achieve the reward. As the domesticated animal starts to make a connection and after a preprogrammed number of instances this “Master” will start to trigger the “touch it” audio file to be played when sensor has been triggered. The instances can be reset to “0” via a reset button. When the Naming activity selection is made by placing (1) tagged item on the associated hooks, this deactivates the touch screen sensor and activates a RFID-RC522 or like tag reader sensors. When a sensored item is placed on the item hook, the tag reader reads the associated item tag that is incorporated into the item, and the weight of the tagged item lowers the hook and activates the vibration sensor within the hook. Instead of triggering the “Touch It” verbal cue via the touch screen, the audio file of “Touch”+“Item Name” is triggered. If the item is touched and/or moved, the verbal cues and treats signify a job well done. As the single item is mastered, a 2nd item is placed on the 2nd hook and read by the tag reader. Touching or moving the correct item triggers the rewards. When 2 items exist on the Activity unit, the unit can instruct to touch the named items randomly. Once the first two items are acknowledged without fail, 1 of the items remains on the Activity unit and the 2nd is replaced with a different tagged item to accommodate learning the names of many items. (4) Individual Activity units can be added to the system for teaching lights on/off, opening doors, closing doors, pushing a handicap door opener button, finding hidden tagged items and placing in the basket, etc

FIG. 3 Represents the basic behavior shaping system of this invention. As in nature, mammals have a stepped progressive warning system prior to punishment for unacceptable behavior. This invention also uses a stepped system based on verbal cues consisting of stronger tones as each progressive warning has been ignored. These verbal communications consists of an initial unique warning verbal cue “Thats 1” such as “AAAA” signifying the domesticated animal needs to think twice about what they are doing or about to do by breaching the “Thats's 1” boundary. “Thats 2” consists of stronger verbiage to include verbal cues such as “BAD”, “LEAVE IT”, “OFF”, “OUT”, etc, depending on that particular behavioral activity. “Thats 3” consists of an ultrasonic sound that progresses with limitations in both dB and frequency to discourage continued infractions of the “Thats 2” level. With use of a warning system, the domesticated animal has the opportunity to retreat/comply prior to being disciplined. This method encourages the domesticated animal to choose wisely and to understand the process of not challenging the verbal cues. Because this invention is consistent in enforcing the rules, the rules of co-existence become easily understandable and quickly compliant regardless if a human is present or not. The goal of this electronic method is to put power into the verbal warnings so the domesticated animal chooses to immediately comply with the owners verbal cues knowing the ultrasonic sounds will play if non-compliant. Instead of owner having to be heavy handed with other electronic devices, this invention places powerful authority into simple human verbal cues and affords the domesticated animal to learn to associate the verbal cues with their chosen actions. By teaching the domesticated animal the difference between acceptable activities and unacceptable activities they become thinking partners and not reactive partners.

Each Guardian unit is configured the same but can be set for various tasks. The Counter Guardian, for example, is programmed to send out a That's 1 warning digital code for an initial verbal warning such as “AAAA” to the Slave if a distance such as 3′ has been breached (based on proximity calculations). That's 2 is triggered if a distance such as 2′ has been breached with an audio trigger for a 2nd level audio file such as “LEAVE IT or BAD”. If the “Slave” remains in the Step 2 position for more than 1 instance (calculated in milliseconds), Step 3 will be activated with the sounding of a progressive, but limited, ultrasonic sound and will increase in both dB and frequency until the “Slave” retreats. If the “Slave” retreats at any level, the Guardian will trigger the Slave to play the audio file such as “Good or Yes” to indicate the correct choice has been achieved. This system helps the domesticated animal understand the difference between the human verbiage for acceptable and unacceptable behavior. Since the verbal cues are created in the owners own voice, this gives powerful control to the humans voiced verbal commands outside of using this invention.

FIG. 4 Is representative of the potential configuration for the joysticks “Master” remote. This remote was developed for long range directional/instructional use. It was also developed for mobility challenged humans that wish to participate in remote controlled activities such as agility type disciplines. The joystick can be custom programmed to meet the needs of the owner/handler. The Joystick “Master” is configured based on using the x/y coordinates of the joystick position. Each x/y axis is programmed to send a specific digital code to the “Slave” device based on the x/y position. This figure demonstrates a “possible” verbal cue, x/y axis configuration but can be customized to fit the requirements of the handler and activity.

FIG. 5 Is representative of the features that can be used for off leash distance control. Using proximity technology, the “Master” can be set for allowed distances of off leash free work without the worry of having a run away or owner constantly correcting the canine. The distance is calculated based on the proximity of the “Slave” in relationship to the “Master”. If the “heel, On-Me, or GO PLAY” options are selected on the Master, as the canine approaches the respective distance boundaries, “Thats 1” warning will automatically be triggered. If the canine continues toward the respective boundary, a “Thats 2” warning will automatically be triggered. If the canine breaches the boundary, the ultrasonic audio file will progressively increase in both dB and frequency until the “Slave” device retreats to the acceptable distance area. The ultrasonic sound lessens in dB and frequency as the retreat to the acceptable area is approached and will turn off when within the acceptable area. If at any time there is a retreat into the “approved” area, the reward of “Good/Yes” audio file is played to indicate a correct choice has been made. Likewise if a selection has not been made by the handler, the “Slave” can automatically trigger a retreat routine when the signal received falls below a certain level or if communication with the handler has been blocked by obstructions. This feature will keep the “Slave” device within an area of communication. This makes it a self-correcting system so the handler can enjoy a leash free walk.

FIG. 6 Represents the potential placement for existing canine goggles outfitted with a video cam set up and the potential placement of the “Slave” units within a Search and Rescue type harness. The “Slave” device and the video camera set ups can all be fitted onto existing commercially available canine wrap around goggles and various search and rescue harnesses by use of Velcro or snapped housing units. In order to allow a forward unobstructed view by the line of sight of the S&R canine, the simple video camera was placed centered on the goggles. In order to reduce the weight of a directional handler operated camera, a simple camera is used with positioning of the camera completed using verbal cues to the canine of “look left”, “look right”, “look down”, “look up”, etc. The goggle unit comes with its own antennae.

Patents

| | | |
|---|---|---|
| U.S. Pat. No. 10,426,140 B2 | Oct. 1, 2019 | Kelly |
| U.S. Pat. No. 10,130,077 | Nov. 20, 2018 | Bianci |
| U.S. Pat. No. 7,861,676 B2 | Jan. 4, 2011 | Kates |
| U.S. Pat. No. 10,721,912 | Jul. 28, 2020 | Hanson |
| U.S. Pat. No. 10,485,218 | Nov. 26, 2019 | Biancci |
| U.S. Pat. No. 10,349,631 B2 | Jul. 16, 2019 | Bonge |
| U.S. Pat. No. 10,314,288 B2 | Jun. 11, 2019 | Davis |
| U.S. Pat. No. 10,278,365 | May 7, 2019 | Nir |
| U.S. Pat. No. 10,238,092 | Mar. 26, 2019 | Bonge |
| U.S. Pat. No. 10,264,765 | Apr. 23, 2019 | Chu |
| U.S. Pat. No. 8,838,260 | Sep. 16, 2014 | Patchet |
| U.S. Pat. No. 10,660,313 B1 | May 26, 2019, | Riley |
| U.S. Pat. No. 10,306,870 | Jun. 4, 2019 | Torres |
| U.S. Pat. No. 10,575,497 B2 | Mar. 3, 2020 | Torres |

1. A wireless based electronic conversion of the inventors training methods configured specifically to consistently and concisely self-teach collared, harnessed or haltered domesticated animal(s) our human verbal cues, human co-existence rules, how to differentiate between acceptable and unacceptable behavioral verbal cues, easily associate the owners pre-recorded verbal cue with the activity and/or task, and with electronic components configured in such a manner to achieve these goals. This system is designed to place the power of control within the owner's verbal cues by use of a stepped reward/deterrent process universal to all mammal groups.

2. The method of claim 1 focuses on using a universal mammal stepped process for the reward/warning system created by nature and converted into consistent human verbiage with various voice tones. The 3 stepped verbal warning system is backed up with a progressively stepped but limited ultrasonic frequency thereby allowing the domesticated animal the ability to “choose wisely” prior to the disciplinary stimulus, with a positive reinforcement verbal cue such as “good” or “yes” for retreat and/or confirmation of a correct choice made thereby humanely and safely teaching the domesticated animals the difference between acceptable and unacceptable behavior verbiage. This stepped process also teaches the owner how to correctly and consistently communicate expectations of co-existence rules.

3. The method of claim 1 is achieved using wireless technology comprised of 2 communicating units; a receiving unit hereinafter known as the “Slave” device fitted within the collar, harness or halter worn by a domesticated animal, and multiple “Master” devices, consisting of either standalone unit(s) or handler operated unit(s).

4. The method of claim 1 for verbal cues consists of owner recording various simple verbal cues with limits of up to 200 individual verbal cues via an online instructional software platform. The verbal cues are recorded once and assigned a computer generated unique line item code, with the code being used for the audio file name/playback on the “Slave” unit, the voice recognition/activation features of the “master” handheld unit as well as the transmitted digital code from the “Master” to the “Slave” devices. The correctly formatted verbal cues are downloaded from the personal computer onto the “Slave” device's SD card or data storage chip via an USB port, and then separately downloaded onto a voice activation chip within the handheld voice activated “Master” device via an USB port. The verbal cue file code, when activated by the “Masters” activation system is sent from the “Master” to the “Slave” via wireless technology where the “Slave” sounds the corresponding audio file on the “Slave” device.

5. The method of claim 3 “Slave” unit consists of a microprocessor connected with an interface to a separate electronic audio component. The primary microprocessor is dedicated to the wireless receiver for managing the digital code transmitted from the “Master”. The 2nd component is responsible for playing the audio file based on the digital code received by the primary. The electronic components are miniaturized and configured in a linear fashion to reduce bulk, correctly align any additional weight without having to overly tighten the collar/harness/halter, and to improve the aesthetics of electronic collars, harness or halters. All broadcasted audio files reside on a SD insertable card within the “Slave” device and triggered by a simple digital code sent from the respective “Master” unit(s).

6. The method of claim 3 includes multiple configurations of a “Master” unit all consisting of a wireless transmitter or transceiver and the necessary components to accommodate required tasks.

7. The method of claim 4 includes standalone units, called Guardians, do not require human interaction and are specifically designed to self-educate the domesticated collared, harnessed or haltered animal owners co-existence rules specifically when an owner is not present. The Guardians are only capable of relaying specific behavioral molding verbal cue codes and are programmed with various proximity ratings in order to calculate the infraction with appropriate warning leveled response sent to the “Slave” device. If a boundary has been breached, the Guardian transmits a digital code via a transmitter or transceiver to the “Slave” device to trigger a specific audio file to be played on the collar, harness or halter. Using the foundational verbiage for molding behavior, three levels of infractions may exist to include an initial warning (That's 1) such as “AAAA”, a secondary or level 2 warning (That's 2) such as “BAD”, “Leave It”, “Off”, “Out”, etc, with increased voice tones, a disciplinary measure (That's 3) of an ultrasonic frequency being triggered for continued infractions, and a verbal reward such as a soothing “good” or “yes” praise with any retreat being calculated signifying a correct choice has been made.

8. A method of claim 4 includes handheld “Master” units, are human operated and comprised of a transmitter or transceiver, depending on the task. The basic handheld “Master” is configured with push button selections for multiple “Slave” recipients, behavioral molding verbal cues and a joystick whereas the x/y positions of the joystick are assigned digital codes for each respective verbal cue. The joystick x/y axis positions can be customized for various activities such as directional verbal cues, agility competition verbal cues for mobility challenged handlers, or verbal cues for the bird hunting dog. This “Master” is limited in the transmission of verbal cue digital codes due to the size of the unit and the restrictions of x/y possible configurations. The joystick configuration can either be a raised unit or accessed via a touch screen OLED device.

9. A method of claim 4 includes the voice activated “Master” unit. In addition to the standard “Master” components this “Master” is owner/handler operated and comprised of a voice recognition chip and a headset for hands free use. Upon speaking the exact pre-recorded verbal cue into the microphone this “Master” transmits the line item code to the “Slave” device where the audio file with same line item number is then sounded from the “Slave” device.

10. A method of claim 4 includes the “Activity Master”, a standalone unit with various electronic sensors designed to protect the unit from mauling and to teach the collared, harnessed or haltered domesticated animal the association between verbal cues and specific activities or tasks. The Activity unit is comprised of touch sensors, RFID readers, tilt switches, vibration sensors, a transmitter or transceiver for “Master/Slave” communication, a wireless chip accessed via wi-fi or Bluetooth for programming daily routines and a treat dispenser in order to teach human verbal cues for specific activities and tasks such as naming an item, turning on/off a light switch, retrieving tagged toys and putting in a basket, etc. The unit can be configured to assist in setting a routine via the wi-fi/computer interface for scheduling events to help prevent separation anxiety. Individual, task specific Activity Masters can be programmed to help set a routine for tasks such as “outside” through a doggie door to assist in toilet training. The unit consists of 3 microprocessors, 1 to control the “Master/Slave” communication, 1 to process the activity associated sensors and 1 to manage the wi-fi routine features each using the 12C interface to establish communication between all microprocessors.

11. A wireless based video miniature device placed on canine goggles for streaming the dogs view. The video cam is miniaturized for weight considerations and placed in the top center of the dog goggles. The miniaturized video cam does not have any controls but instead views are created by training the canine to “look left”, “look right”, “look up”, “look down”. This claim includes the miniaturized video cam, a snapped or Velcro system for goggle placement, a transmitter, its own battery pack, its own antennae and microprocessor. A small cable is ran from the video cam to a small lightweight waterproof enclosure that attaches to the back strap of the goggles.
